(19) United States
(12) Patent Application Publication
(10) Pub. No.: US 2020/0274615 A1
(43) Pub. Date: Aug. 27, 2020

(54) WIRELESS COMMUNICATION SYSTEM AND TRANSMISSION TERMINAL

(71) Applicant: Panasonic Intellectual Property Management Co., Ltd., Osaka (JP)

(72) Inventor: Hideyuki YAMADA, Hyogo (JP)

(21) Appl. No.: 16/874,046

(22) Filed: May 14, 2020

Related U.S. Application Data
(63) Continuation of application No. PCT/JP2018/037323, filed on Oct. 5, 2018.

(30) Foreign Application Priority Data
Nov. 15, 2017 (JP) 2017-219618

(51) Int. Cl. H04B 10/116; H04B 10/114; H04W 12/06

(52) U.S. Cl. CPC H04B 10/116; H04W 12/06; H04B 10/1143

(57) ABSTRACT

A wireless communication system includes a reception terminal used by a user, and a transmission terminal that transmits data to the reception terminal in a wireless communication method having directivity. The transmission terminal notifies of a directional area connectable by the wireless communication method when a connection authentication in the wireless communication method with the reception terminal is successful. The transmission terminal does not notify of the directional area connectable by the wireless communication method when the connection authentication with the reception terminal is failed.

### TECHNICAL FIELD

The present disclosure relates to a wireless communication system and a transmission terminal using a wireless communication method having directivity.

### BACKGROUND ART

A wireless communication system is disclosed in which a reception terminal of a user displays an optimal direction of wireless communication during wireless communication between terminal devices (PTL 1).

### CITATION LIST

### Patent Literature

PTL 1: Unexamined Japanese Patent Publication No. 2005-202492

### SUMMARY

However, when wireless communication is performed using a wireless communication method having directivity, it is difficult for a user to locate a position suitable for wireless communication in the wireless communication method having directivity.

A wireless communication system according to the present disclosure includes a reception terminal used by a user, and a transmission terminal that transmits data to the reception terminal in a wireless communication method having directivity. The transmission terminal notifies of a directional area connectable by the wireless communication method when a connection authentication in the wireless communication method with the reception terminal is successful. The transmission terminal does not notify of the directional area connectable by the wireless communication method when the connection authentication with the reception terminal is failed.

Further, the transmission terminal according to the present disclosure performs wireless communication with a reception terminal. The transmission terminal includes a connection authentication unit that performs connection authentication in a wireless communication method having directivity, and a controller. The controller performs control to notify of a directional area connectable by the wireless communication method when the connection authentication is successful. The controller performs control not to notify of the directional area connectable by the wireless communication method when the connection authentication is failed.

The wireless communication system and the transmission terminal according to the present disclosure makes it easy for a user to locate a position suitable for wireless communication in the wireless communication method having directivity during wireless communication using the wireless communication method having directivity.

### BRIEF DESCRIPTION OF DRAWINGS

FIG. 1 is a diagram showing an example of an outer appearance of a wireless communication system according to a first exemplary embodiment.

FIG. 2 is a diagram showing an example of a configuration of the wireless communication system according to the first exemplary embodiment.

FIG. 3 is a diagram showing an example of an operation from a WiGig connection authentication request from a reception terminal to a start of a notification by a notification unit of a transmission terminal in the wireless communication system according to the first exemplary embodiment.

FIG. 4 is a diagram showing an example of an operation from the start of the notification by the notification unit to an end of the notification in the wireless communication system according to the first exemplary embodiment.

FIG. 5 is a diagram showing an example of a notification by visible light when the reception terminal is outside a directional area connectable to a wireless communication method having directivity in the wireless communication system according to the first exemplary embodiment.

FIG. 6 is a diagram showing an example of a notification by visible light when the reception terminal is within the directional area connectable to the wireless communication method having directivity in the wireless communication system according to the first exemplary embodiment.

FIG. 7 is a diagram showing an example of a notification by sound when the reception terminal is outside the directional area connectable to the wireless communication method having directivity in the wireless communication system according to the first exemplary embodiment.

FIG. 8 is a diagram showing an example of a notification by sound when the reception terminal is within the directional area connectable to the wireless communication method having directivity in the wireless communication system according to the first exemplary embodiment.

FIG. 9 is a diagram showing an example of a configuration of a transmission terminal according to a second exemplary embodiment.

FIG. 10 is a diagram showing an example of handling of stored data when a reception terminal is outside a directional area connectable to a wireless communication method having directivity in a wireless communication system according to the second exemplary embodiment.

FIG. 11 is a diagram showing an example of handling of the stored data when the reception terminal is within the directional area connectable to the wireless communication method having directivity in the wireless communication system according to the second exemplary embodiment.

FIG. 12 is a diagram showing an example of display by visible light by a notification unit when a reception terminal is outside a directional area connectable to a wireless communication method having directivity in a wireless communication system according to a first modification.

FIG. 13 is a diagram showing an example of display by visible light by the notification unit when the reception terminal is within the directional area connectable to the wireless communication method having directivity in the wireless communication system according to the first modification.

FIG. 14 is a diagram showing an example of a case where a shade is provided near a light source and a reception terminal is outside a directional area connectable to a wireless communication method having directivity in a wireless communication system according to a second modification.

FIG. 15 is a diagram showing an example of a case where the shade is provided near the light source and the reception terminal is within the directional area connectable to the wireless communication method having directivity in the wireless communication system according to the second modification.

### DESCRIPTION OF EMBODIMENTS

Hereinafter, exemplary embodiments will be described in detail with reference to the drawings accordingly. However, an unnecessarily detailed description may be omitted. For example, a detailed description of a well-known item or a redundant description of substantially the same configuration may be omitted. This is to prevent the following description from being unnecessarily redundant and to facilitate understanding by those skilled in the art.

Note that the attached drawings and the following description are provided for those skilled in the art to fully understand the present disclosure, and are not intended to limit the subject matter as described in the appended claims.

### First Exemplary Embodiment

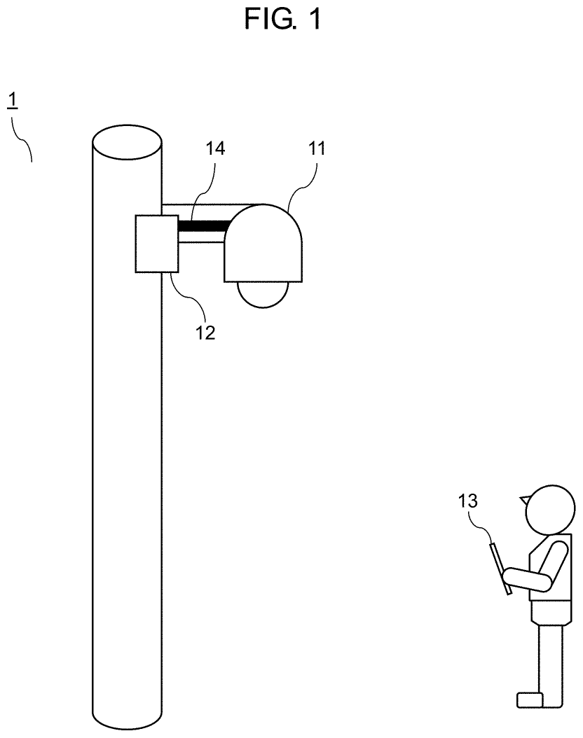

Hereinafter, the present exemplary embodiment will be described with reference to FIGS. 1 to 8.

### [1. Configuration]

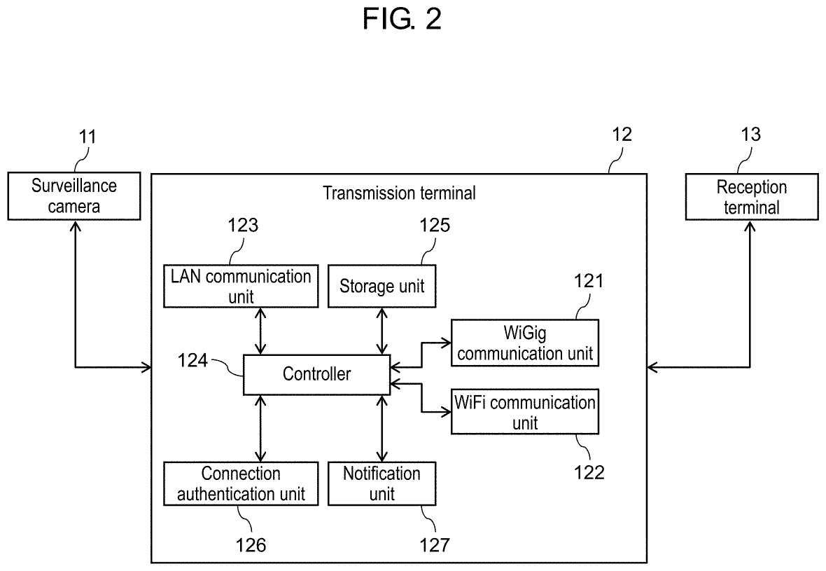

Wireless communication system 1 according to the present exemplary embodiment will be described with reference to FIGS. 1 and 2.

FIG. 1 is a diagram showing an example of an outer appearance of wireless communication system 1 according to the present exemplary embodiment.

In FIG. 1, wireless communication system 1 has transmission terminal 12 and reception terminal 13. Surveillance camera 11 and transmission terminal 12 are installed on a street or the like by a pillar or the like. Surveillance camera 11 may be included in wireless communication system 1.

Surveillance camera 11 transmits captured image data or video data (hereinafter collectively referred to as image data) to transmission terminal 12 via local area network (LAN) cable 14.

Transmission terminal 12 records the image data transmitted from surveillance camera 11, and supplies power to surveillance camera 11 via LAN cable 14. Further, transmission terminal 12 wirelessly communicates with reception terminal 13 using wireless gigabit (WiGig) (registered trademark), wireless fidelity (WiFi) (registered trademark), or the like and transmits the stored image data of surveillance camera 11.

Reception terminal 13 is a terminal having a wireless communication function, such as a personal computer (PC), a tablet, a smartphone, or the like. The user operates reception terminal 13 to download the image data of surveillance camera 11 stored in transmission terminal 12.

The image of surveillance camera 11 is image data of the inside of a store, a street, or the like, and the captured image data may cause an issue of privacy, and the like. Surveillance camera 11 and transmission terminal 12 that store the image data are therefore installed at a height inaccessible to people in consideration of security to prevent a destruction by passers-by or prevent the image data of surveillance camera 11 from being stolen.

FIG. 2 is a diagram showing an example of a configuration of wireless communication system 1 according to the present exemplary embodiment.

In FIG. 2, transmission terminal 12 has WiGig communication unit 121, WiFi communication unit 122, LAN communication unit 123, controller 124, and storage unit 125.

WiGig communication unit 121 transmits and receives WiGig packets. WiGig communication unit 121 is configured by an antenna for transmitting and receiving a wireless signal, a wireless signal control circuit, and the like.

WiFi communication unit 122 transmits and receives WiFi packets. WiFi communication unit 122 is configured by an antenna for transmitting and receiving a wireless signal, a wireless signal control circuit, and the like. Note that parts that can be shared with WiGig communication unit 121 may be commonized.

Here, two wireless communication methods of WiGig and WiFi used in the present exemplary embodiment will be described in detail. WiGig is a wireless system in a 60 GHz band and has a high frequency, and thus is a wireless communication method having rectilinearity and directivity. Further, since WiGig does not pass through shields such as a wall and a window and is easily attenuated, for example, some have a communication distance of about 10 m. WiGig corresponds to a second wireless communication method of the present disclosure.

On the other hand, WiFi is a wireless communication in a 2.4 GHz band or 5.0 GHz band, has a lower frequency than WiGig, and is a (nondirectional) wireless communication method having no directivity. In addition, WiFi passes through shields such as a wall or a window, and has a longer communication distance than WiGig. WiFi corresponds to a first wireless communication method of the present disclosure.

LAN communication unit 123 receives the image data of surveillance camera 11 as LAN packets. LAN communication unit 123 is configured by a LAN interface unit, a LAN signal control circuit, and the like.

Controller 124 controls WiGig communication unit 121, WiFi communication unit 122, LAN communication unit 123, storage unit 125, connection authentication unit 126, and notification unit 127. Specifically, controller 124 stores the image data of the surveillance camera 11 received by LAN communication unit 123 in storage unit 125.

Further, controller 124 receives a request for management information from reception terminal 13 using WiFi communication unit 122, and transmits the requested management information to reception terminal 13.

Here, the management information is, for example, a list of the image data of surveillance camera 11 stored in transmission terminal 12, and specifically, list information such as a camera ID (camera name) and date and time. The list information may include a thumbnail image.

Further, controller 124 authenticates the connection for performing WiGig communication with reception terminal 13 using WiFi communication unit 122 and connection authentication unit 126.

Further, when the connection is authenticated with reception terminal 13, controller 124 notifies of a directional area where WiGig communication can be performed using notification unit 127 such that reception terminal 13 is included in the directional area where WiGig communication can be performed in WiGig communication unit 121.

Further, controller 124 receives selection information requested by reception terminal 13, and transfers the image data of surveillance camera 11 stored in storage unit 125 using WiGig communication unit 121. Controller 124 includes a calculation unit, software executed on the calculation unit, and the like.

Here, the selection information is information selected at reception terminal 13 from the list information. One piece of data (one item) may be selected from the list information, or a plurality of the pieces of data or every piece of data may be selected.

Storage unit 125 stores the image data received from surveillance camera 11 via LAN communication unit 123. Storage unit 125 is configured by, for example, a storage device such as a read only memory (ROM), a random access memory (RAM), and a NAND flash memory (NAND FLASH).

Connection authentication unit 126 performs connection authentication for performing WiGig communication with reception terminal 13. The connection authentication is performed with reception terminal 13 as described below, for example.

### (1) WiGig Connection Authentication

Reception terminal 13 transmits information for WiGig connection authentication via WiFi. Then, in transmission terminal 12, connection authentication unit 126 collates the information for WiGig connection authentication transmitted from reception terminal 13, and authenticates the connection when the information matches.

As a specific example, reception terminal 13 inputs a service set identifier (SSID), a pre-shared key (PSK), or the like as the information for WiGig connection authentication. Then, connection authentication unit 126 authenticates the connection on the basis of whether the SSID, key information such as PSK, or the like transmitted from reception terminal 13 matches an SSID, key information such as PSK, or the like held in connection authentication unit 126.

(2) Connection Authentication Concurrently with WiFi

The connection in WiFi with reception terminal 13 is authenticated, and the connection in WiGig is concurrently authenticated.

As a specific example, the connection is authenticated on the basis of whether the SSID, a password, and the like for WiFi connection authentication match the SSID, password, and the like held in connection authentication unit 126.

### (3) Unique Authentication

Reception terminal 13 transmits unique connection authentication for downloading the image data via WiFi. Then, in transmission terminal 12, connection authentication unit 126 collates the information for connection authentication transmitted from reception terminal 13, and authenticates the connection when the information matches.

As a specific example, reception terminal 13 accesses a Web server of transmission terminal 12, and inputs a download ID, a password, and the like as the unique authentication. Connection authentication unit 126 authenticates the connection on the basis of whether the download ID and the password transmitted from reception terminal 13 match a download ID and a password held in connection authentication unit 126.

Notification unit 127 notifies of the directional area where the WiGig communication can be performed in WiGig communication unit 121. As a means of the notification, for example, there is a notification using visible light so as to correspond to the directional area where WiGig communication can be performed, and a notification using a sound when the reception terminal is within the directional area where WiGig communication can be performed.

The directional area where WiGig communication can be performed is an area where WiGig connection is possible between transmission terminal 12 and reception terminal 13.

Notification unit 127 is configured by, for example, light emitting diode (LED) illumination when notification unit 127 notifies by visible light, and configured by a speaker when notification unit 127 notifies by sound.

### [2. Operation]

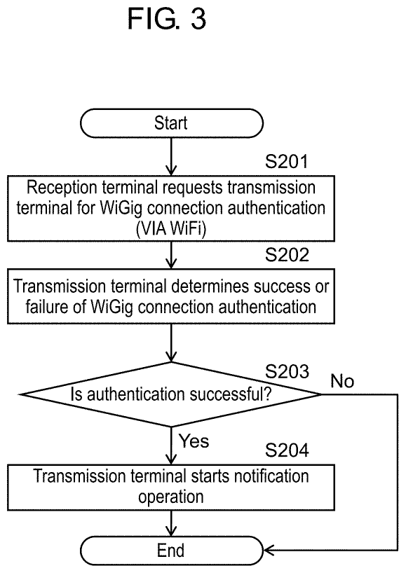

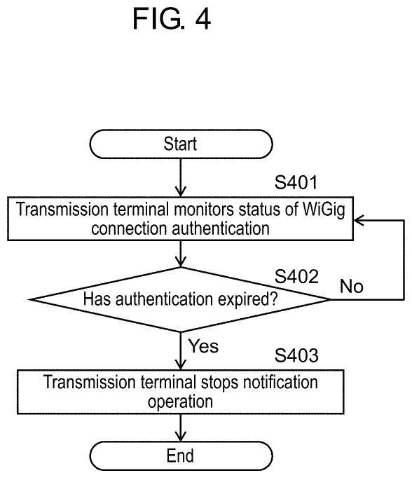

The operation of wireless communication system 1 of the present exemplary embodiment will be described using FIGS. 3 and 4.

FIG. 3 is a diagram showing an example of an operation from a WiGig connection authentication request in reception terminal 13 to a start of notification by notification unit 127 in transmission terminal 12 in wireless communication system 1 according to the present exemplary embodiment.

Step S201: Reception terminal 13 requests transmission terminal 12 for WiGig connection authentication using WiFi.

Step S202: After receiving the WiGig connection authentication request from reception terminal 13, connection authentication unit 126 determines whether the WiGig connection authentication is successful. Specifically, as described above about connection authentication unit 126, a success or failure of WiGig is determined as, for example, (1) WiGig connection authentication, (2) connection authentication concurrently with WiFi, and (3) unique authentication.

Step S203: Connection authentication unit 126 transmits a success or failure of the WiGig connection authentication to controller 124.

Step S204: In step S203, when the WiGig connection authentication is successful (Yes in S203), controller 124 starts the notification using notification unit 127. For example, notification unit 127 notifies by displaying the directional area where the WiGig communication can be performed by visible light, and guiding the user to the directional area where the WiGig communication can be performed by sound. With the start of the notification by notification unit 127, the operation in the WiGig connection authentication ends.

When the WiGig connection authentication is failed in step S203 (No in S203), controller 124 ends the processing of the WiGig connection authentication with reception terminal 13 that has requested the WiGig connection authentication.

FIG. 4 is a diagram showing an example of an operation from the start of a notification by notification unit 127 to the end of a notification in wireless communication system 1 according to the present exemplary embodiment.

Step S401: Transmission terminal 12 monitors a status of the WiGig connection authentication. Specifically, while notifying by notification unit 127, controller 124 monitors whether the status of the WiGig connection authentication with reception terminal 13 continues.

Step S402: Controller 124 determines by monitoring whether the WiGig connection authentication has expired.

Note that the following cases, for example, correspond to an expiration of the authentication.

(First Case) when the Connection is Terminated by User Operation

In a first case, for example, after the end of WiGig connection authentication between transmission terminal 12 and reception terminal 13, transmission terminal 12 receives, from reception terminal 13 via WiFi or WiGig, information that the WiGig connection is terminated (disconnected).

(Second Case) when the Wireless Connection is Disconnected Due to Abnormality

In a second case, transmission terminal 12 detects a disconnection of the WiFi connection, for example, when reception terminal 13 moves out of a WiFi connectable communication area.

Step S403: When it is determined in step S402 that the WiGig connection authentication has expired (Yes in S402), notification unit 127 ends the notification. Thus, when notification unit 127 displays the directional area where WiGig communication can be performed by visible light, the display using visible light ends. When notification unit 127 guides the user to the directional area where WiGig communication can be performed by sound, the guidance by sound ends.

When it is determined in step S402 that the WiGig connection authentication has not expired (No in S402), monitoring of the state of the connection authentication in step S401 is continued.

After the end of the notification by notification unit 127 in step S403, transmission terminal 12 terminates the WiGig wireless communication with reception terminal 13.

### [3. Effects]

As described above, wireless communication system 1 according to the present disclosure performs wireless communication between transmission terminal 12 and reception terminal 13. Then, from the connection authentication in the wireless communication method having directivity such as WiGig with reception terminal 13 until the expiration of the connection authentication in the wireless communication method having directivity, transmission terminal 12 notifies reception terminal 13 of the directional area connectable by the wireless communication method having directivity.

Thus, when the user having reception terminal 13 wants to use the wireless communication in the wireless communication method having directivity such as WiGig, the user can easily locate the communication area communicable by the wireless communication method having directivity.

Further, wireless communication system 1 according to the present disclosure uses the wireless communication method such as WiFi to perform the connection authentication in the wireless communication method having directivity such as WiGig.

Accordingly, the wireless communication system according to the present disclosure can wirelessly communicate using WiFi in advance, and thus can perform the connection authentication for communication using WiGig via WiFi.

Further, since WiFi is a nondirectional wireless communication method compared to WiGig, the user does not have to consider wireless directivity in the connection authentication for communication using WiGig.

In addition, by using WiFi, as described above about connection authentication unit 126, the connection authentication by WiGig can be determined using information used in the WiFi connection authentication for connection authentication.

Further, as notification unit 127, wireless communication system 1 according to the present disclosure notifies, by visible light or sound, of the directional area connectable to reception terminal 13 by the wireless communication method having directivity such as WiGig.

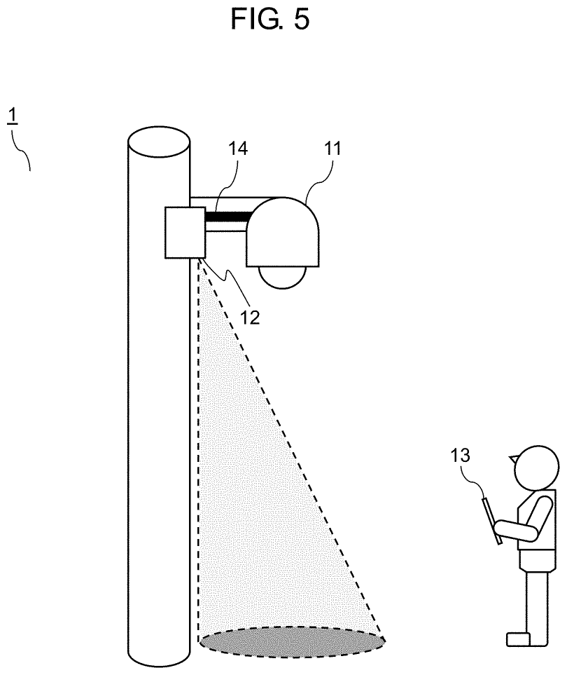

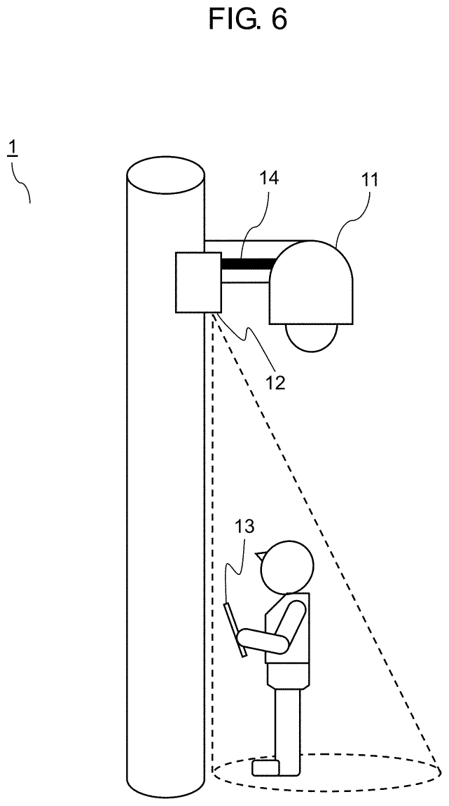

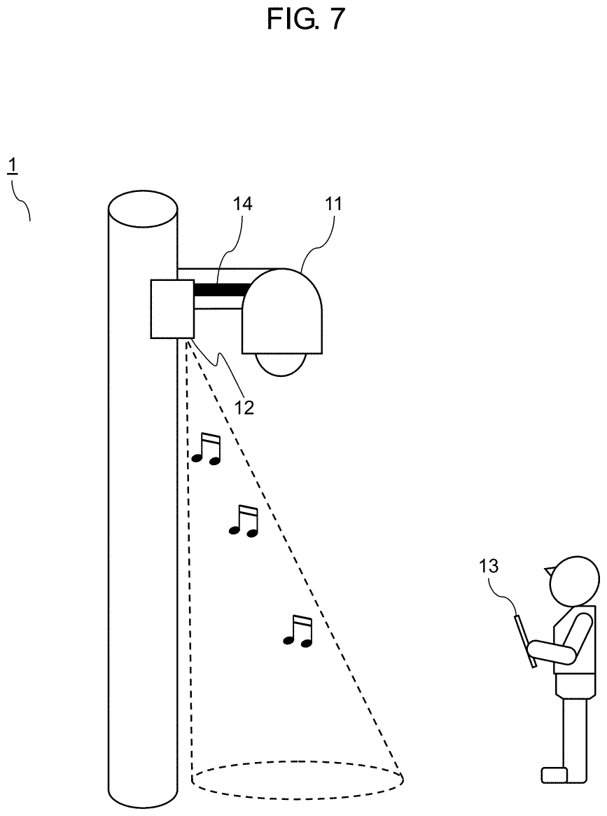

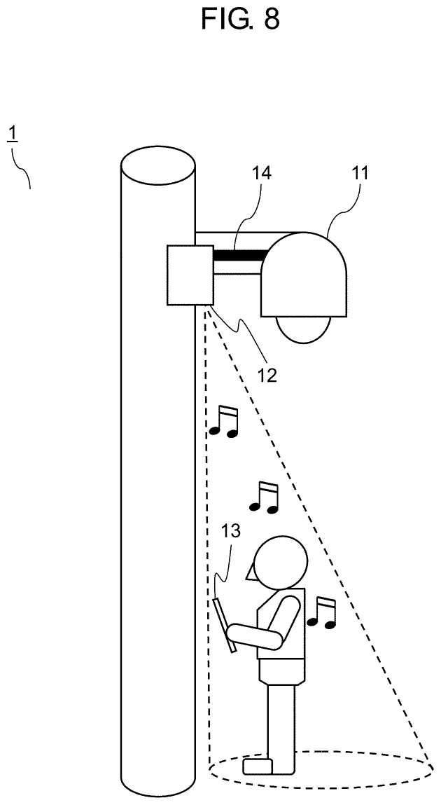

Here, the notification by visible light will be described with reference to FIGS. 5 and 6, and the notification by sound will be described with reference to FIGS. 7 and 8.

FIG. 5 is a diagram showing an example of the visible light when reception terminal 13 is outside the directional area connectable to the wireless communication method having directivity in wireless communication system 1 according to the present exemplary embodiment.

FIG. 6 is a diagram showing an example of the visible light when reception terminal 13 is within the directional area connectable to the wireless communication method having directivity in wireless communication system 1 according to the present exemplary embodiment.

As shown in FIG. 5, when reception terminal 13 is outside the directional area connectable to the wireless communication method having directivity, the notification unit 127 illuminates visible light so as to correspond to the communication area connectable by WiGig in order to move the user to the communication area connectable by WiGig.

Then, as shown in FIG. 6, the user moves to a communication area connectable by WiGig, and reception terminal 13 receives the image data from transmission terminal 12 by WiGig connection, and then terminates the connection by WiGig. In this way, when transmission terminal 12 detects the expiration of the WiGig connection authentication with reception terminal 13, notification unit 127 ends the illumination of the visible light. Further, when reception terminal 13 does not end the connection by WiGig, moves away from the WiGig connectable communication area, and also moves away from the WiFi connectable communication area, transmission terminal 12 detects the expiration of WiGig connection authentication and ends the illumination of the visible light.

FIG. 7 is a diagram showing an example of the sound when reception terminal 13 is outside the directional area connectable to the wireless communication method having directivity in wireless communication system 1 according to the present exemplary embodiment.

FIG. 8 is a diagram showing an example of the sound when reception terminal 13 is within the directional area connectable to the wireless communication method having directivity in wireless communication system 1 according to the present exemplary embodiment. In FIGS. 7 and 8, a directivity speaker is used as notification unit 127.

As shown in FIG. 7, when reception terminal 13 is outside the directional area connectable to the wireless communication method having directivity, the user cannot hear the sound.

However, as shown in FIG. 8, when the user is within the directional area, the user can hear the sound from the directivity speaker.

Then, when reception terminal 13 is within the directional area connectable by the wireless communication (WiGig) method having directivity, and the WiGig connection authentication expires, the directivity speaker stops producing a sound.

Accordingly, it is possible for the user to easily locate the communication area communicable by the wireless communication method having directivity by visible light or sound.

### Second Exemplary Embodiment

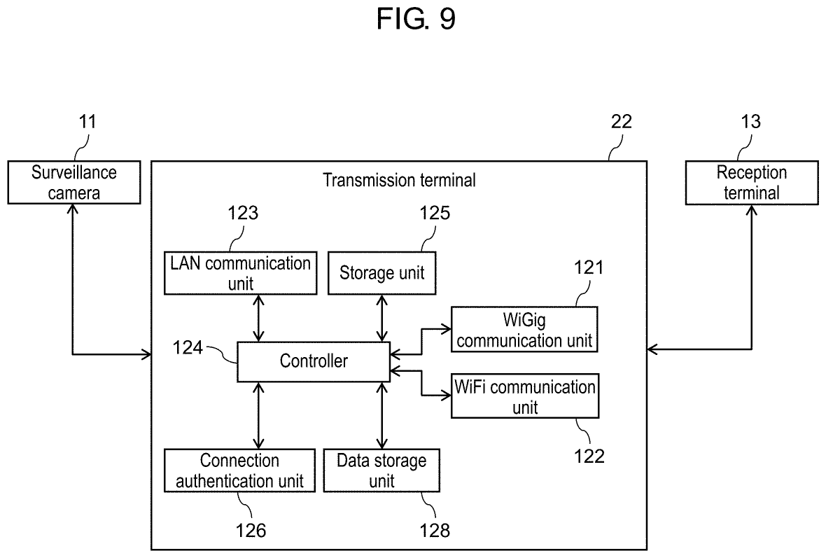

Hereinafter, an example different from the first exemplary embodiment as a second exemplary embodiment will be described with reference to FIGS. 9 to 11.

FIG. 9 is a diagram showing an example of a configuration of transmission terminal 22 of wireless communication system 2 according to the second exemplary embodiment.

Transmission terminal 22 shown in FIG. 9 is different in that data storage unit 128 is provided instead of notification unit 127 of transmission terminal 12 shown in FIG. 2 according to the first exemplary embodiment. The other configuration is similar to the configuration in FIG. 2, and thus the description is omitted.

Data storage unit 128 stores data indicating whether reception terminal 13 is within the directional area where WiGig communication can be performed in WiGig communication unit 121. Further, for example, data storage unit 128 may locate a position of reception terminal 13 using a beacon signal, global positioning system (GPS) information, or the like in the directional area, and store data indicating in which direction reception terminal 13 is to move to be within the WiGig connectable communication area, or store data of a sample image indicating the user's standing position in advance.

The operations of the second exemplary embodiment are different from the operations of the first exemplary embodiment in that the notification operation is started by transmitting the data stored in data storage unit 128 to reception terminal 13 via WiFi communication unit 122 in step S204 of FIG. 3, and in that the notification operation is ended by terminating the transmission of the data stored in data storage unit 128 when it is determined that the WiGig connection authentication has expired in step S403 of FIG. 4.

Thus, until the expiration of the connection authentication in the wireless communication method having directivity such as WiGig, transmission terminal 22 notifies of the directional area connectable by the wireless communication method having directivity using the data stored in data storage unit 128.

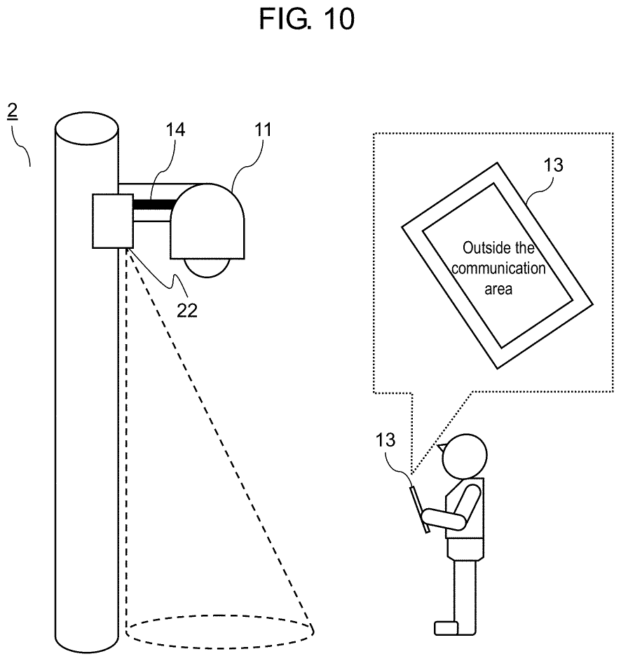

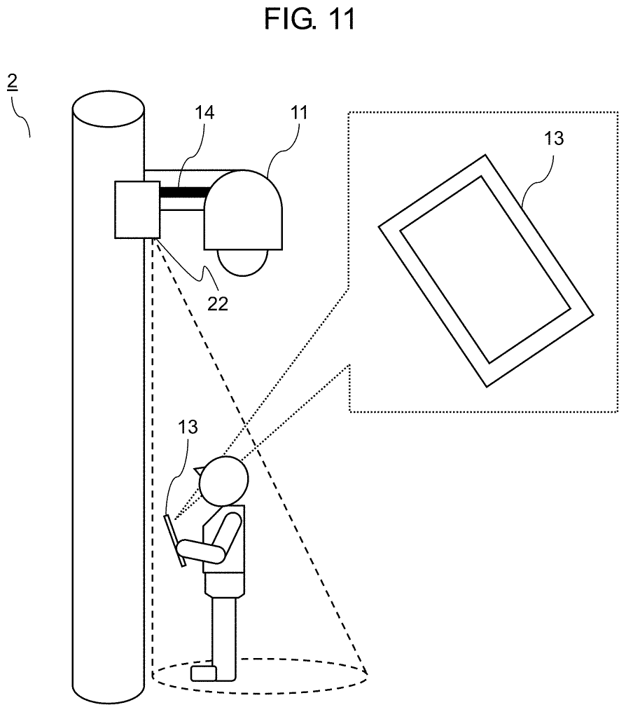

Here, the notification using data storage unit 128 will be described with reference to FIGS. 10 and 11.

FIG. 10 is a diagram showing an example of handling of the stored data when reception terminal 13 is outside the directional area connectable to the wireless communication method having directivity in wireless communication system 2 according to the present exemplary embodiment.

FIG. 11 is a diagram showing an example of handling of the stored data when reception terminal 13 is within the directional area connectable to the wireless communication method having directivity in wireless communication system 2 according to the present exemplary embodiment.

As shown in FIG. 10, when reception terminal 13 is outside the directional area connectable to the wireless communication method having directivity, controller 124 of transmission terminal 22 notifies reception terminal 13 using the data stored in data storage unit 128 in order to move the user to the WiGig connectable communication area. For example, controller 124 transmits, via WiFi communication unit 122, data for displaying, for example, “outside the communication area” on a display screen of reception terminal 13 which means reception terminal 13 is outside the communication area.

Further, transmission terminal 22 may locate the position of reception terminal 13 using a beacon signal, GPS information, or the like, and may display in which direction to move to be within the WiGig connectable communication area.

Then, as shown in FIG. 11, transmission terminal 12 ends the data transmission when the WiGig connection authentication expires. For example, as shown in FIG. 11, data indicating “outside the communication area” is not displayed on the display screen of reception terminal 13.

The user can thus easily locate the communication area communicable by the wireless communication method having directivity by communicating the notification data.

### (First Modification)

In wireless communication system 1 according to the first exemplary embodiment, an example has been described in which notification unit 127 of transmission terminal 12 is configured by LED illumination when the communication area communicable by the wireless communication method having directivity is notified by visible light. However, for the notification using visible light, for example, external light such as sunlight or light from surrounding illumination may have an influence, making it difficult for the user to see the visible light.

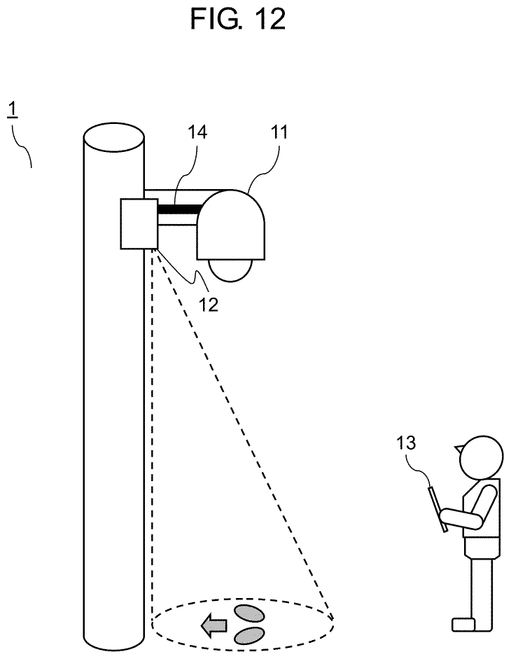

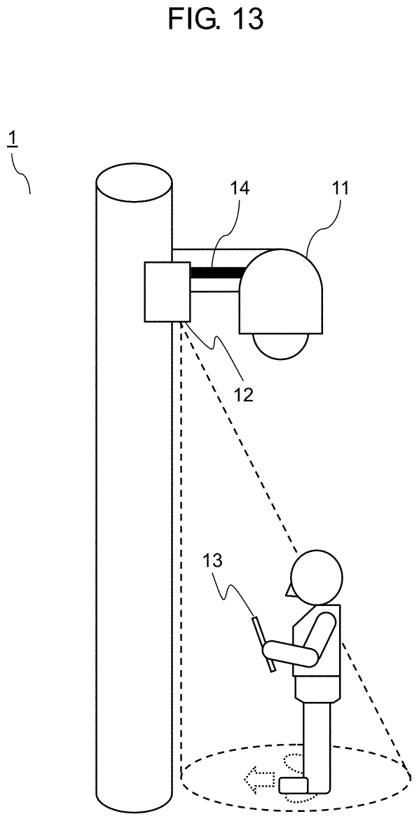

Thus, a first modification will be described with reference to FIGS. 12 and 13 in which reception terminal 13 is notified of the communication area communicable by the wireless communication method having directivity by displaying a figure using visible light such that the user can more easily locate the communication area.

FIG. 12 is a diagram showing an example of a display of a figure by visible light when reception terminal 13 is outside the communication area connectable to the wireless communication method having directivity in wireless communication system 1 according to the first exemplary embodiment.

As shown in FIG. 12, notification unit 127 of transmission terminal 12 draws a figure on the ground using laser light or the like in a visible light range, and notifies the user of a position where reception terminal 13 is included in the communication area by the figure of the emitted light.

Further, as shown in FIG. 12, the notification using a figure representing an arrow and the notification of the user's standing position using a figure representing an ellipse can cope with an appropriate angle in consideration of a radio polarization.

FIG. 13 is a diagram showing an example of display by visible light when reception terminal 13 is within the communication area connectable to the wireless communication method having directivity in wireless communication system 1 according to the first modification.

By displaying a figure using visible light as shown in FIGS. 12 and 13, the user can recognize the notification even in an environment where it is difficult to view an image using ordinary illumination, for example, spotlight.

### (Modification 2)

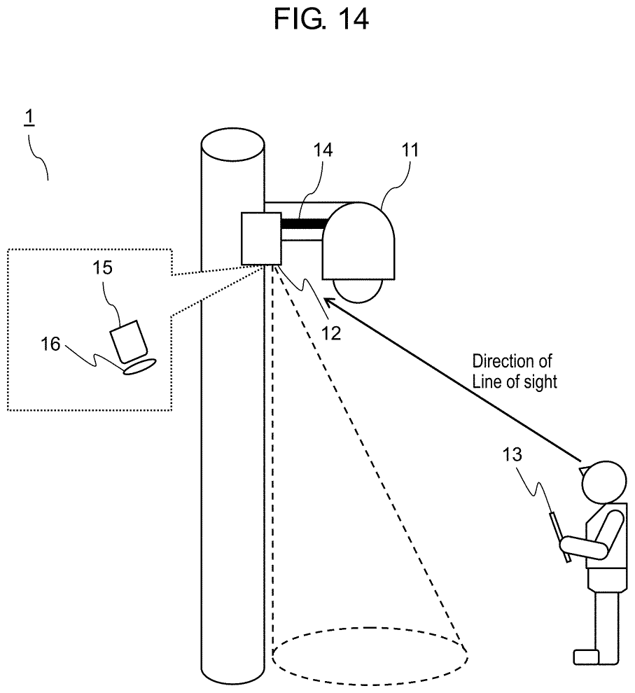

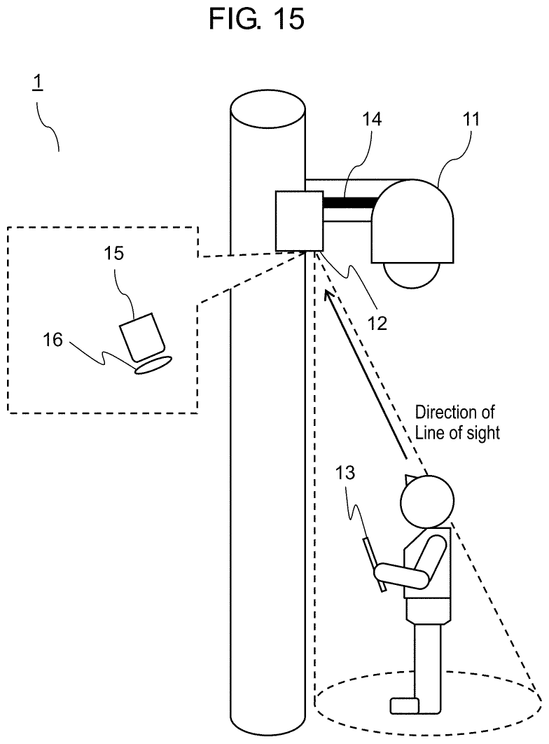

A second modification will be described reference to FIGS. 14 and 15 in which light source 15 and shade 16 are used to notify of the communication area communicable by the wireless communication method having directivity by visible light.

FIG. 14 is a diagram showing an example of a case where notification unit 127 of transmission terminal 12 has light source 15 and shade 16, and reception terminal 13 is outside the communication area connectable to the wireless communication method having directivity in wireless communication system 1 according to the second modification.

As shown in FIG. 14, shade 16 is provided near light source 15. Shade 16 is disposed at an angle corresponding to the directivity of the wireless communication method having directivity. Thus, the user outside the communication area cannot confirm lighting of light source 15.

FIG. 15 is a diagram showing an example of a case where shade 16 is provided near light source 15 and reception terminal 13 is within the communication area connectable to the wireless communication method having directivity in wireless communication system 1 according to the second modification.

As shown in FIG. 15, the user can visually recognize the lighting of light source 15 and knows that the user has entered the communication area only when the user sees light source 15 from within the communication area of the wireless communication method having directivity.

With the configuration as shown in FIGS. 14 and 15, even when the surroundings are bright due to external light, the user can locate the communication area of the wireless communication method having directivity. In other words, the user can recognize that the user is within the communication area, as a notification from transmission terminal 12, when the user can visually recognize the lighting of light source 15. The user can recognize that the user is outside the communication area, as a notification from transmission terminal 12, when the user cannot visually recognize the lighting of light source 15.

In FIGS. 14 and 15, an example using shade 16 is shown. However, the present disclosure is not limited to this, and it is sufficient as long as a direction of light is limited. In this regard, a lens may be used instead of shade 16.

### Other Exemplary Embodiments

In the present disclosure, WiFi between the transmission terminal and the reception terminal may be either an ad hoc system or an infrastructure system. That is, the system may be a direct WiFi connection method between the transmission terminal and the reception terminal or a WiFi connection method between the transmission terminal and the reception terminal via an access point (base station).

Further, reception terminal 13 downloads the image data of surveillance camera 11 stored in the transmission terminal in accordance with the user's operation on reception terminal 13, but the present disclosure is not limited to this. That is, a configuration may be adopted in which the image data is downloaded to reception terminal 13 without the user's operation.

Further, the management information of the transmission terminal is an example of the list information. However, the management information may be data of a fixed folder set in advance instead of the list information.

When it is determined in step S402 that the WiGig connection authentication has expired, controller 124 (notification unit 127) ends the notification, but the present disclosure is not limited to this. For example, controller 124 may be configured to stop the notification operation by the user's operation after the notification operation starts and before the reception terminal starts downloading. Further, the notification of the directional area may be stopped when the WiGig connection authentication is completed, the transmission terminal notifies of the WiGig connectable directional area, the reception terminal is positioned in that directional area, and the WiGig connection starts between the transmission terminal and the reception terminal. This is because when the WiGig connection is started, the notification of the directional area may be no longer necessary.

Further, an example has been described where a sound is produced using the directivity speaker as notification unit 127 to move the user to the WiGig connectable communication area when reception terminal 13 is in the directional area connectable to the wireless communication method having directivity. However, the present disclosure is not limited to this. For example, a configuration may be adopted in which the sound may be produced using notification unit 127 when reception terminal 13 is outside the directional area connectable to the wireless communication method having directivity. Specifically, for example, a melody may be produced, or an announcement that the user is outside the WiGig connectable communication area may be made in voice.

In an announcement, the transmission terminal may locate the position of reception terminal 13 using a beacon signal, GPS information, or the like, and announce in which direction to go to be within the WiGig connectable communication area.

The above has described the exemplary embodiments as examples of the technique in the present disclosure. In this regard, the accompanying drawings and the detailed description have been provided.

Therefore, not only components that are essential for solving the problem but also components that are not essential for solving the problem may also be included in the components described in the accompanying drawings and the detailed description in order to exemplify the above technique. Thus, it should not be immediately recognized that the non-essential components are essential because the non-essential components are described in the accompanying drawings and the detailed description.

Further, since the above-described exemplary embodiments are for exemplifying the technique in the present disclosure, various changes, replacements, additions, omissions, and the like can be made within the scope of the claims or equivalents thereof.

### INDUSTRIAL APPLICABILITY

The wireless communication system and the transmission terminal according to the present disclosure is useful for notifying the user of the communication area communicable by the wireless communication method having directivity when wireless communication is performed between the transmission terminal and the reception terminal of the user.

### REFERENCE MARKS IN THE DRAWINGS

1, 2 wireless communication system
11 surveillance camera
12, 22 transmission terminal
13 reception terminal
14 LAN cable
15 light source
16 shade
121 WiGig communication unit
122 WiFi communication unit
123 LAN communication unit
124 controller
125 storage unit
126 connection authentication unit
127 notification unit
128 data storage unit

1. A wireless communication system comprising:
a reception terminal used by a user; and
a transmission terminal that transmits data to the reception terminal in a wireless communication method having directivity,
wherein the transmission terminal notifies of a directional area connectable by the wireless communication method when a connection authentication in the wireless communication method with the reception terminal using a communication method is successful, and the transmission terminal does not notify of the directional area connectable by the wireless communication method when the connection authentication with the reception terminal is failed.

2. The wireless communication system according to claim 1, wherein the transmission terminal stops notifying of the directional area when the connection authentication expires.

3. The wireless communication system according to claim 1, wherein when the connection authentication is successful and the reception terminal is outside the directional area, the reception terminal notifies that the reception terminal is outside the directional area.

4. The wireless communication system according to claim 1, wherein
the transmission terminal has a notification unit, and
the notification unit notifies of the directional area by visible light or sound.

5. The wireless communication system according to claim 1, wherein
the transmission terminal has a data storage unit, and
the transmission terminal notifies of the directional area using data included in the data storage unit.

6. The wireless communication system according to claim 1, wherein the wireless communication method having directivity is wireless gigabit (WiGig).

7. A transmission terminal that performs wireless communication with a reception terminal, the transmission terminal comprising:
a connection authentication unit that performs connection authentication in a wireless communication method having directivity; and
a controller that performs control to notify of a directional area connectable by the wireless communication method when the connection authentication is successful, and performs control not to notify of the directional area connectable by the wireless communication method when the connection authentication is failed.

8. The transmission terminal according to claim 7, wherein the controller stops notifying of the directional area when the connection authentication expires.

9. The transmission terminal according to claim 7, further comprising a notification unit,
wherein the controller notifies of the directional area by causing the notification unit to produce visible light or sound.

10. The transmission terminal according to claim 7, further comprising a data storage unit,
wherein the controller notifies of the directional area using data included in the data storage unit.

11. The transmission terminal according to claim 7, wherein the wireless communication method having directivity is wireless gigabit (WiGig).
